(19) United States
(12) Patent Application Publication
(10) Pub. No.: US 2014/0258838 A1
(43) Pub. Date: Sep. 11, 2014

(54) EXPENSE INPUT UTILITIES, SYSTEMS, AND METHODS

(71) Applicant: SAP AG, Walldorf (DE)

(72) Inventors: Harald Evers, Walldorf (DE); Marcel Sommerfeld, Walldorf (DE)

(73) Assignee: SAP AG, Walldorf, (DE)

(21) Appl. No.: 13/794,657

(22) Filed: Mar. 11, 2013

(51) Int. Cl. G06F 17/24

(52) U.S. Cl. CPC G06F 17/243
USPC 715/234

(57) ABSTRACT

Systems and methods for expense input utilities include providing an image of an expense-related document for display with an expense form. A selection of a portion of the image and a selection of an input field of the expense form may be received. Optical character recognition may be performed on the selected portion of the image to identify a text string and the selected input field may be populated with the identified text string. Metadata associated with the input field may be associated with the text string and the expense form may be converted into structured data that includes the metadata and the text string.

### BACKGROUND

Some computing systems today allow for users to input expense information for purposes of expense tracking, reporting, and reimbursement. For example, a business traveler may seek reimbursement for the expenses that he or she incurred during a business trip via his or her company's travel expense management system. To input the expense data into such a system, a user may be required to enter each data item of each expense by hand, e.g., the travel expense management system may require a user to enter separate expense items for a traveler's lodging, meals, airfare, and other incidental expenses. The travel expense management system may also require the traveler to enter any number of details about a particular expense item. For example, the travel expense management system may require a user entering an expense item for a hotel stay to identify the name of the hotel, the location of the hotel, the rates for the hotel, when the stay took place, and other such information. Similarly, the system may require the user entering a meal expense item to identify the name and location of the restaurant, the cost of the meal, the amount of tip given, any non-reimbursable costs from the meal (e.g., the company may not reimburse a business traveler for alcoholic beverages), and other such information. While an expense management system generally simplifies accounting from the standpoint of a company, the entry of expense information into such a system by users may actually create more work for the users than with non-computerized measures. It remains challenging and difficult to devise computerized techniques for the input of expense information.

### SUMMARY

Implementations of the systems and methods for expense input utilities are described herein. One embodiment is a computerized method for inputting expense data. The method includes receiving, at a processing circuit, an image of an expense document. The method also includes providing the image for display with an expense form, the expense form having an input field with associated metadata. The method further includes receiving a selection of a portion of the image from an interface device. The method additionally includes performing, by the processing circuit, character recognition on the selected portion of the image to identify text in the selected portion of the image. The method also includes prompting the selection of an input field of the expense form. The method further includes populating, by the processing circuit, the input field of the expense form with the identified text from the image of the expense document. The method additionally includes converting the expense form into structured data comprising the metadata associated with the input field and the identified text.

Another embodiment is a system for inputting expense data. The system includes a processing circuit configured to receive an image of an expense document and to provide the image for display with an expense form, the expense form having an input field with associated metadata. The processing circuit is also configured to receive a selection of a portion of the image from an interface device and to perform character recognition on the selected portion of the image to identify text in the selected portion of the image. The processing circuit is further configured to prompt the selection of an input field of the expense form and to populate the input field of the expense form with the identified text from the image of the expense document. The processing circuit is yet further configured to convert the expense form into structured data comprising the metadata associated with the input field and the identified text.

A further embodiment is a computer-readable storage medium having machine instructions stored therein, the instructions being executable by a processor to cause the processor to perform operations. The operations include receiving an image of an expense document and providing the image for display with an expense form, the expense form having an input field with associated metadata. The operations also include receiving a selection of a portion of the image from an interface device and performing character recognition on the selected portion of the image to identify text in the selected portion of the image. The operations further include prompting the selection of an input field of the expense form. The operations yet further include populating the input field of the expense form with the identified text from the image of the expense document. The operations also include converting the expense form into structured data comprising the metadata associated with the input field and the identified text.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computerized expense management system, in accordance with an exemplary embodiment;

FIG. 2 is an illustration of character recognition being used to input data in a computerized expense management system, according to an exemplary embodiment;

FIG. 3 is an illustration of character recognition being used on a portion of an image of an expense document to input data in an electronic expense form, according to an exemplary embodiment;

FIG. 4 is another illustration of character recognition being used on a portion of an image of an expense document to input data into an electronic expense form, according to an exemplary embodiment;

FIG. 5 is a schematic block diagram of a processing circuit configured to facilitate the entry of expense data into an electronic expense form, according to an exemplary embodiment; and

FIG. 6 is a flow diagram of a process for inputting expense data into an expense management system, according to an exemplary embodiment.

Like reference numbers and designations in the various drawings indicate like elements.

### DETAILED DESCRIPTION

According to some aspects of the present disclosure, an expense management system is configured to provide a user interface that facilitates the entry of expense data. An image of an expense document is presented to a user during entry of an expense form (e.g., a set of one or more input fields configured to receive information about an incurred expense). Exemplary expense documents may include, but are not limited to, receipts, invoices, and other documents related to an expense. For example, an image of an expense document may be a digital image of a receipt captured via a camera or scanner. Character recognition is used by the expense management system to identify one or more text strings located in the image. In some embodiments, the portion of the image on which the character recognition is performed may be selected via a user interface device. Thus, only the contents located in the portion of the image selected by a user may be subject to identification using character recognition in some cases. The expense management system may also be configured to use the identified text to populate a selected input field of the expense form. In some embodiments, the data entered into the expense form may be converted into structured data (e.g., data that includes metadata that describes the entered expense data and/or describes how the entered data is related).

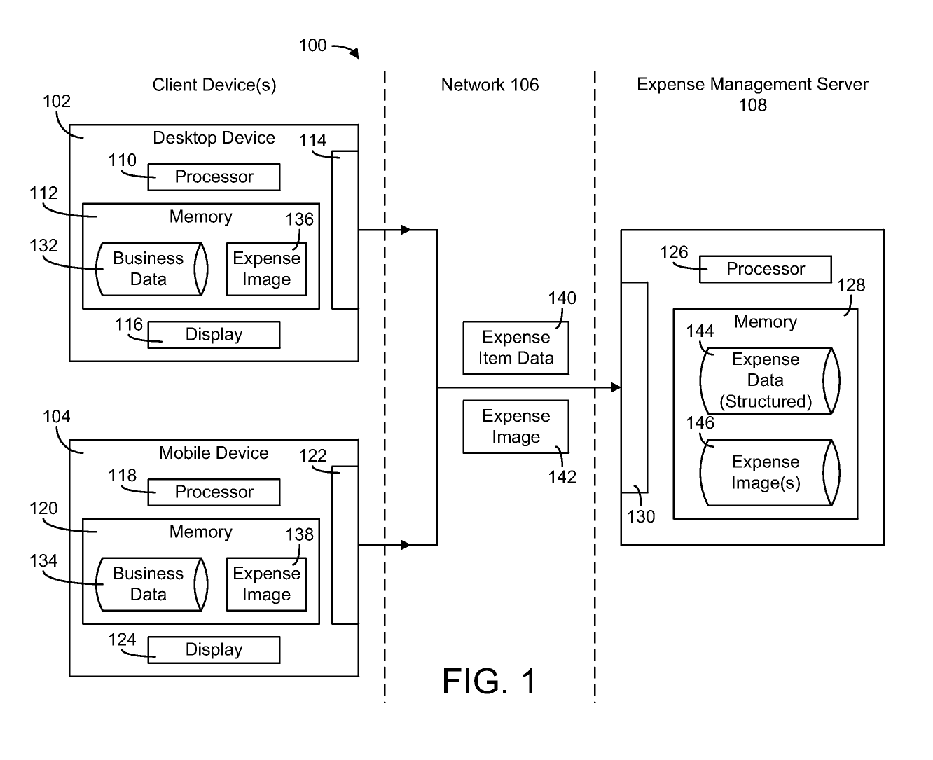

Referring to FIG. 1, a computerized expense management system 100 is shown, in accordance with an exemplary embodiment. System 100 may include any number of computing devices which communicate with one another via a network 106. As shown, system 100 may include one or more client devices 102, 104 (e.g., a first through nth client device) in communication with an expense management server 108. Client devices 102, 104 may generally be operated by users to input expense data into expense management server 108. Such expense data may include, for example, expense item data 140 or an image 142 of an expense document, such as a receipt, invoice or the like associated with the expense item.

Client devices 102, 104 may be of any number of different types of electronic devices configured to communicate via network 106. For example, client device 102 may be a desktop computer (e.g., a computing device intended to remain stationary during use). In another example, client device 104 may be a mobile device (e.g., a computing device which can be moved during use such as a tablet computing device, a cellular phone, a laptop computer, or the like). Each of client devices 102, 104 may include a processing circuit that includes a processor configured to execute machine instructions stored in a memory. For example, client device 102 may include a processor 110 and memory 112 while client device 104 includes a processor 118 and memory 120. Each of the processing circuits of client devices 102, 104 may also include one or more hardware interfaces 114, 122, respectively. Interfaces 114, 122 are configured to receive or transmit data via network 106, other networks, or user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, a motion-sensor, etc.). For example, interface 114 of client device 102 may receive input data from a pointing device, such as a mouse. In some embodiments, client devices 102, 104 include electronic displays 116, 124, respectively. Electronic displays 116, 124 may be touch-sensitive displays (e.g., capacitance-sensitive displays, resistance-sensitive displays, etc.) that both receive information from, and convey information to, a user. In other embodiments, electronic displays 116, 124 may only convey information to a user (e.g., the displays are not touch-sensitive). The one or more user interface devices may be internal to the housings of client devices 102, 104 (e.g., built-in displays, microphones, etc.) or external to the housings of client devices 102, 104 (e.g., a monitor connected to client device 102, a speaker connected to client device 104, etc.), according to various implementations.

Network 106 may be any form of data network that relays information between client devices 102, 104 and expense management server 108. For example, network 106 may include the Internet and/or other types of data networks, such as a local area network (LAN), a wide area network (WAN), a cellular network, satellite network, etc. Network 106 may also include any number of computing devices (e.g., computer, servers, routers, network switches, etc.) that are configured to receive and/or transmit data within network 106. In other words, network 106 may include other devices configured to relay data between client devices 102, 104 and expense management server 108. Network 106 may include any number of hardwired and/or wireless connections. For example, client device 102 may communicate wirelessly (e.g., via WiFi, cellular, radio, etc.) with a transceiver that is hardwired (e.g., via a fiber optic cable, a CAT5 cable, etc.) to other devices in network 106. In addition to client devices 102, 104 and expense management server 108, network 106 may be configured to relay data between any number of different computing devices.

Similar to client devices 102, 104, expense management server 108 may be a computing device having a processing circuit that includes a processor 126 configured to execute machine instructions stored in a memory 128. Expense management server 108 may also include one or more hardware interfaces 130 configured to receive data and/or to communicate data to another device (e.g., to or from a user interface device, to or from network 106, etc.). In some embodiments, expense management server 108 may be implemented using multiple computing devices. For example, expense management server 108 may be implemented using multiple servers, one or more data centers, as a cloud computing environment, or the like. In such cases, processor 126 represents the collective set of processors of the devices and memory 128 represents the collective set of data storage devices.

According to various embodiments, expense management server 108 is configured to store expense data 144. As shown, business data 132, 134 on client devices 102, 104, respectively, may be sent to expense management server 108 as expense item data 140. For example, client device 104 may present an input screen to display 124 that allows a user to input various business data 134, which may include expense item data 140. An expense input screen may be provided to display 124 by a stand-alone application stored and executed locally by client device 104 or may be provided to client device 104 by expense management server 108 (e.g., as a thin client, as a webpage, etc.). Expense management server 108 may also be configured to use expense data 144 for purposes of reporting, data analysis, or other such functions. For example, expense data entered via client device 104 may be included in a monthly report generated by expense management server 108 and provided to client device 102 for display. Expense management server 108 may also utilize workflows to process expense data 144 in response to receiving expense item data 140. For example, an expense item entered via client device 104 may be forwarded to a user's manager to be approved for reimbursement.

Expense data 144 may be in a structured format, to facilitate the functions of expense management server 108. As used herein, a structured format refers to any data format in which metadata is associated with expense-related values. For example, the value “Hotel California” may be associated with the metadata label “Hotel Name” in expense data 144. In one embodiment, metadata labels may also be inter-related, thereby forming a data structure. For example, an Expense Item object may belong to the hierarchy Expense Item>Hotel Stay>Hotel Name. Metadata objects in expense data 144 may or may not be associated with an actual expense-related value. For example, some metadata objects in expense data 144 may be used to organize and classify other metadata objects. The metadata objects may also be used by expense management server 108 to search for expense-related values in expense data 144. For example, one expense report may search only for expenses that were incurred during the previous financial quarter.

Images of expense documents may also be stored in system 100. As shown, client devices 102, 104 may store images 136, 138 of expense documents in their respective memories. Expense documents may be, but are not limited to, physical or electronic documents that contain information regarding an expense item. For example, an expense document may be a physical (e.g., paper) receipt or invoice for an expense item. In another example, an expense document may be a confirmation webpage or email in electronic form. Expense images 136, 138 may be received by client devices 102, 104 via their respective interfaces 114, 122. In one embodiment, an expense image may be received by one of client devices 102, 104 via an interface device configured to capture an image of an expense document (e.g., a camera, a scanner, etc.). For example, client device 104 may be a mobile device that includes an integrated camera. When the user of client device 104 incurs an expense, he or she may take a photograph of a receipt to capture expense image 138. In further embodiments, expense images 136, 138 may include a screen capture of an email, webpage, or other electronic expense document. For example, expense image 136 may be a screen capture of a confirmation webpage in an image format (e.g., JPG, TIFF, etc.).

An image of an expense item may be associated with corresponding expense item data. For example, expense image 142 may be an image of a receipt associated with expense item data 140 (e.g., data regarding a hotel stay may be associated with an image of a payment receipt for the stay). Expense management server 108 may also receive and store an image of an expense item, in one embodiment. For example, expense image 142 of an expense item may be communicated from client device 102 or client device 104 to expense management server 108 and stored in expense images 146. Expense images 146 may be associated with corresponding expense data in expense data 144 and may be presented along with expense data 144 by expense management server 108. For example, a manager approving the reimbursement of an expense item may be presented with detailed information about the expense item from expense data 144 as well as an image of the receipt for the expense from expense images 146.

According to various embodiments, optical character recognition (OCR) may be used in system 100 on an image of an expense document to facilitate the entry of expense item. Client devices 102, 104 or expense management server 108 may be configured to perform character recognition on an image of an expense document to identify text in the image. In one embodiment, the entirety of the image may be analyzed and identified text values used to generate expense item data and/or metadata for the values. For example, an image of a receipt may include the recognized text “Total: $15.00.” In such a case, the “Total” keyword may be matched by system 100 to a corresponding metadata object (e.g., “total expense,” “total amount,” etc.) and its corresponding value and currency unit of $15.00 USD associated with the object. Thus, character recognition performed on an image of an expense document may be used to automatically generate expense item data 144 for use by expense management server 108 (e.g., without further input from a user). In cases in which keywords are also identified and matched to metadata objects, the structure of the expense data may also be automatically determined based on an image of an expense document. The recognized expense item data may be directly stored in expense management server 108 or may first be presented to a user for review. For example, recognized text values may be used to pre-populate fields of an expense item report screen being presented to a user via either of displays 116, 124.

In further embodiments, character recognition may be performed on a portion of an expense image selected via a user interface device in system 100 and not on the remainder of the image. In some cases, character recognition on an image as a whole may result in a slower experience for the user attempting to enter expense item data into system 100. For example, a user may be required to double check and correct any erroneously identified values in an expense image. If the number of these errors is high enough, it may actually take the user longer to correct the errors than if the user had simply entered the information him or herself (e.g., by typing in the information). Such errors may be due to a non-sophisticated character recognition program, deviations in the format of expense documents, and other factors. In addition, performing character recognition on the entire image is done asynchronously, e.g., a user may be required to wait for the recognition process to complete before entering expense item data. Thus, a user may be able to select which portions of an expense image are analyzed using character recognition in some embodiments.

System 100 may also be configured to allow a user to specify the metadata associated with an expense-related value identified using character recognition, in some embodiments. In other words, character recognition may only be performed in system 100 to identify expense-related values and not the metadata for the values, according to some embodiments. For example, an expense item input screen presented to a user via one of client devices 102, 104 may include a number of input fields. Each input field may already be associated with a metadata object. For example, a “total expense” input field may be associated with a corresponding metadata object. Such an input screen may be configured to generate structured expense data based on a user's inputs via its input fields, since its input fields are already associated with metadata objects. In some embodiments, system 100 may be configured to populate a selected input field of a displayed expense screen with text recognized in a selected portion of an expense image. For example, a user may select the input field labeled “total expense” and select the corresponding portion of the image that contains the relevant information (e.g., the image portion that displays “$15.00), either before or after selecting the input field. In response, system 100 may analyze the selected portion of the image and populate the selected input field with the value. The user may then be able to confirm that the text was correctly identified and review the expense data before transmission to expense management server 108.

In one example, assume that a user of client device 102 wishes to submit a meal receipt for reimbursement while traveling on a business trip. Using client device 102, the user may take a digital image of the receipt using a camera of client device 102. The user may also access expense management server 108 to submit his or her travel expense for reimbursement using client device 102. In doing so, an expense item entry screen may be presented on display 116 having various input fields for information such as the name and location of the restaurant, the date and time the expense was incurred, the total cost of the bill, the names of the diners, and other such information. To expedite the entry of this information by the user, the image of the meal receipt may be presented in conjunction with the expense item entry screen. In response to the user selecting one of the input fields and a portion of the image of the receipt, client device 102 may perform character analysis on the image to identify a text string and populate the selected input field with the identified text string, thereby allowing the user to quickly enter in details about the meal expense. In response to receiving a confirmation from a user interface device that the data entered into the expense item entry screen is correct, client device 102 may then send the expense data regarding the meal and/or the image of the receipt to expense management server 108.

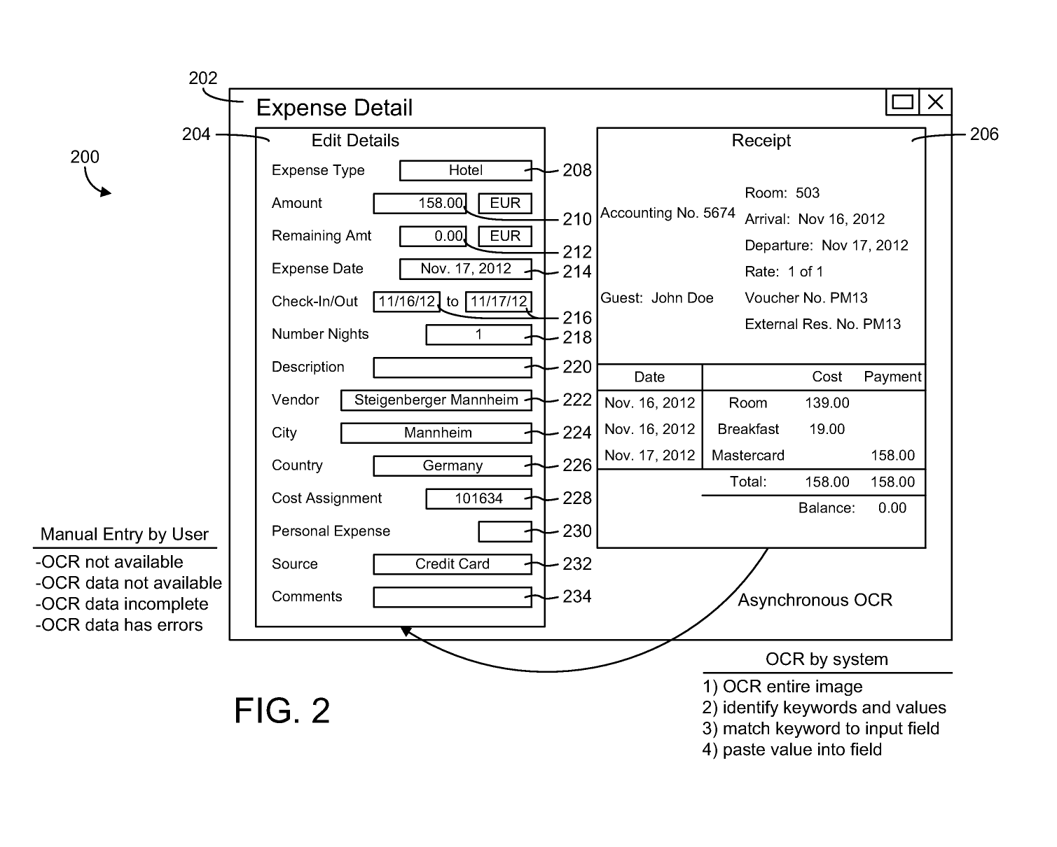

Referring now to FIG. 2, an illustration 200 is shown of character recognition being used to input data into an electronic expense form, according to an exemplary embodiment. As shown, an electronic expense form 204 may be provided to a display 202 by an expense management system. In some embodiments, expense form 204 may be generated by a stand-alone application running locally on the computing device having display 202. In other embodiments, expense form 204 may be provided to the computing device having display 202 over a network from another computing device (e.g., expense form 204 may be a webpage, thin client application, remote desktop application, etc.).

Expense form 204 may include any number of different input fields configured to receive data from a user interface device, such as a keypad (e.g., a physical or virtual keypad), mouse or other pointing device, or touch screen display. The number and types of input fields on expense form 204 may vary, depending on the type of expense. For example, input field 208 may receive a selection of an expense type (e.g., hotel-related expenses, restaurant-related expenses, transportation-related expenses, etc.). In response, expense form 204 may display the corresponding input fields for the selected type of expense. In other embodiments, the expense type may be selected via a menu screen, a menu displayed in conjunction with expense form 204, or other similar user interface mechanisms. As shown in the example of illustration 200, assume that a user has selected to input data regarding a hotel-related expense via input field 208. In response, expense form 204 may display input fields 210-234. Input field 210 may receive the total amount of the expense and input field 212 may receive the remaining unpaid amount of the expense, if any. In conjunction with input fields 210, 212, expense form 204 may also include input field 214 configured to receive data regarding when the expense was incurred.

Expense form 204 may also include fields specific to a hotel stay, in one embodiment. For example, input fields 216 may receive data regarding the check-in and check-out dates for the hotel stay and input field 218 may receive the number of nights for the total hotel stay. Alternatively, input field 218 may be an output field configured to calculate and display the number of nights based on the dates entered via input fields 216. Expense form 204 may also include a description field 220 to receive a description of the expense. For example, the business traveler may enter “Electronics Expo” to signify that he stayed in a hotel to attend a particular convention. Expense form 204 may include inputs fields 222-226 to identify the name of the hotel, the city in which it is located, or the country in which it is located, respectively.

Expense form 204 may further include input fields relating to how the expense item should be treated. For example, expense form 204 may include an input field 228 to receive a cost center code and an input field 230 to receive data regarding whether or not the expense was personal in nature. For example, assume that the business traveler stayed one night in the hotel for business reasons, but then stayed another two nights for personal reasons. In such a case, the company may reimburse the traveler for the first night, but the traveler may still remain responsible for the remainder of the bill. Input fields 232, 234 may receive data regarding how the expense was paid and any comments regarding the payment. For example, input field 232 may receive data indicating that the business traveler paid for the hotel stay using a credit card.

In some embodiments, metadata may be associated with the various input fields 208-234 of expense form 204. The metadata may be descriptive metadata (e.g., the type of data input into one of the input fields) and/or structural metadata (e.g., metadata that controls how the data input into the input fields is related or organized). For example, the text “Germany” input via input field 226 may have an associated descriptive metadata attribute “Country.” In another example, the metadata for the expense item entered via expense form 204 may be arranged according to a structure, such as Expense Type>Hotel>Location>Country or another such structure. Using metadata to describe and structure the data input via input fields 208-234 may allow for detailed reports, workflows, or other mechanisms to be implemented in the expense management server. For example, an quarterly expense report may be generated by using the “Expense Date” metadata object (e.g., the metadata associated with input field 214) to restrict a search query to expense items incurred during a particular timeframe. Metadata may be associated with the entries to input fields 208-234 by the local device or an expense management server, in various embodiments. For example, the local device receiving data entries via expense form 204 may associate metadata with the entries and send the entries and metadata in a structured format to the expense management server (e.g., data entries and associated metadata may be communicated using XML or another format that allows metadata to be associated with data values). In another example, the entries to input fields 208-234 may be sent to the expense management server and associated with metadata for purposes of structuring and data storage. In further embodiments, the metadata may be used as part of the structure of a relational database. For example, input fields 208-234 may correspond to table names, column names, or row names of a relational database configured to store data inputted via expense form 204.

According to various embodiments, an image of an expense document may be provided to display 202 in conjunction with expense form 204. As shown, an image 206 of a receipt for a hotel stay may be displayed. Image 206 may be received by the device having display 202 from an interface device, such as a camera or scanner. In another embodiment, image 206 may be received by the device having display 202 from another computing device via a network. Displaying image 206 with expense form 204 may help to facilitate the entry of data into expense form 204. For example, a user may conveniently compare the data in image 206 to the data inputted into expense form 204 to verify its accuracy. In some embodiments, OCR may be performed on image 206 and used to populate expense form 204 with data. The character recognition may be performed by the local device (e.g., the device having display 202) or by another computing device, such as an expense management server, in communication with the local device.

In the example shown, character recognition may be performed asynchronously on image 206. For example, character recognition may be performed on image 206 as a whole when the image is uploaded to the local device or to an expense management server. Generally, OCR allows for the identification of text (e.g., characters or strings of characters) to be identified within a digital image. For example, OCR may identify the text strings “Departure: Nov. 17, 2012” in image 206. In various embodiments, a keyword identified in image 206 using OCR may be matched to keyword associated with one of input fields 208-234. For example, the keyword “Total” recognized from image 206 may be used by the system to determine that the data value “158.00” corresponds to input field 210 of expense form 204. Thus, the entirety of image 206 may be analyzed by the system to pre-populate values into input fields 208-234. Since the actions performed on image 206 by the system are decoupled from the user's input into input fields 208-234, this process is asynchronous from the user's subsequent review and modification of the pre-populated values.

The asynchronous analysis of image 206 as a whole to populate input fields 208-234 can reduce the amount of time spent by the user to input data into expense form 204. However, this requires that a number of conditions are satisfied. First, the OCR service must be available to analyze image 206. Otherwise, the user must manually enter the information into expense form 204. Second, OCR data needs to be available for image 206. In other words, the OCR service needs to be robust enough to recognize the contents of image 206 and determine which identified data values correspond to which input fields of expense form 204. For example, image 206 may be an image of a receipt in any number of different languages and arranged in any number of different formats (e.g., localization effects like right-to-left orientation). If the OCR service is unable to recognize the language or format in image 206, the system may not be able to populate input fields 208-234 and the user must do so by hand. Third, the OCR data needs to be complete. For example, the service may not be able to populate input field 210 if it is able to recognize “158.00” in image 206, but not the keyword “Total” in image 206. In such a case, the user will still need to enter “158.00” into input field 210. Fourth, the OCR data also needs to be free from errors (e.g., improperly identified keywords used to select an input field to populate, an incorrectly identified data value, etc.). In other words, even if the system is able to populate some or all of input fields 208-234, any errors that result from the process must still be corrected by the user. This also increases the potential for erroneous data being used in the expense management system, since it increases the likelihood of a user missing an erroneous entry in expense form 204. In addition, time gaps may between the image capture and an asynchronous OCR process may result in a user having to edit an expense item twice.

According to alternate embodiments, the OCR of image 206 and population of input fields 208-234 by the system may be performed synchronously with actions performed by the user via an input device. In other words, input from a user interface device may be used to control how character recognition is performed on image 206 and/or how expense form 204 is populated with text identified by the performed character recognition. In some embodiments, OCR may be performed only on a selected portion of image 206. For example, data from a user interface device may indicate a particular area of image 206 on which the OCR is to be performed (e.g., the user swipes a finger over the text “158.00” using a touch screen display). Similarly, data from a user interface device may indicate the input field on expense form 204 into which the identified text in image 206 is to be pasted. For example, input field 210 may be selected as the destination after the selected text “158.00” in image 206 is recognized. Either an input field of expense form 204 or a portion of image 206 may be selected first to initiate the copying process, in various embodiments.

In general, synchronous input techniques have been found to be faster than asynchronously performing OCR on the entirety of image 206, since OCR is performed only on selected portions of image 206 rather than its entirety. Also, the input field being selected via a user interface device and not by matching an OCR identified keyword to the input field has the potential to reduce the amount of error by the system when populating the input field. As a result, the user may spend a shorter amount of time to complete expense form 204 than completing expense form 204 entirely by hand or the system attempting to populate all of expense form 204 using OCR on image 206 as a whole.

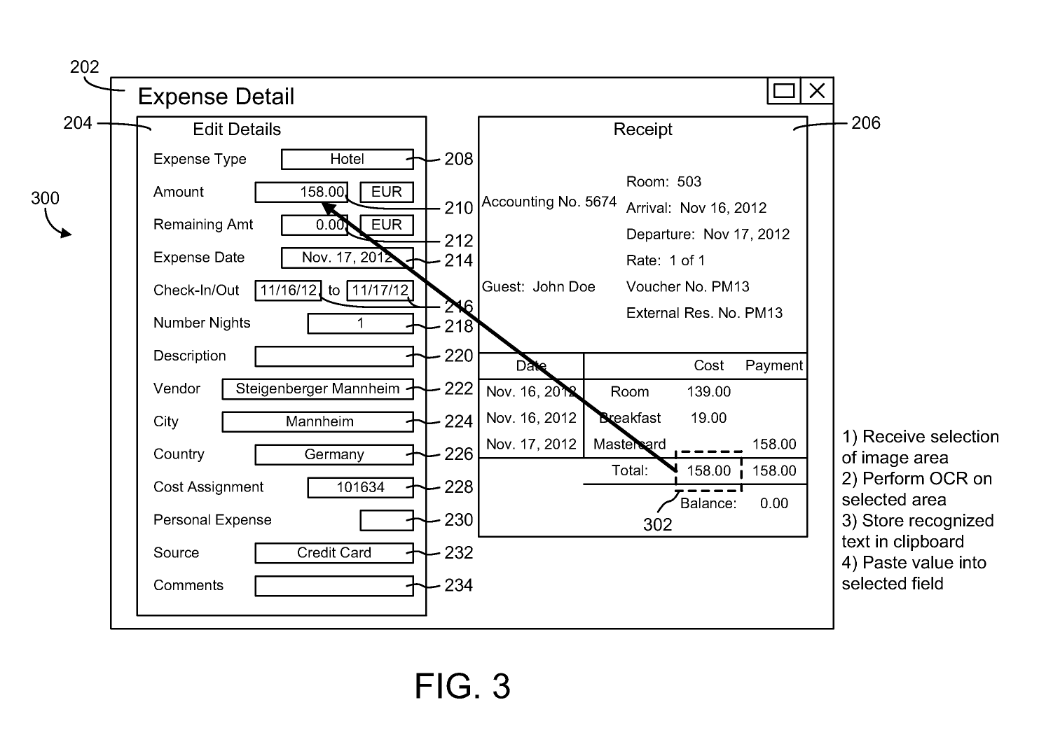

Referring now to FIG. 3, an illustration 300 is shown of character recognition being used on a portion of an image of an expense document to input data into an expense form, according to an exemplary embodiment. In the example shown, assume that the same expense form 204 and image 206 are provided to display 202 as in FIG. 2. In the current example, a portion 302 of image 206 may be selected via a user interface device, followed by the selection of the corresponding input field 210 of expense form 204 by the user interface device, to initiate population of input field 210 with the text from portion 302. OCR may be performed by the system on the selected portion 302 of image 206 to identify one or more strings of text. In some embodiments, the one or more strings of text identified via OCR may be copied to a clipboard utility or similar mechanism and pasted into the selected input field 210.

Portion 302 of image 206 may be selected via a user interface device in any number of different ways. In some embodiments, portion 302 may be selected for OCR in response to a swiping motion being performed using a user interface device. For example, portion 302 may be selected in response to a user swiping his or her finger over portion 302 using a touch-sensitive display. In another example, portion 302 may be selected in response to a user swiping a cursor over portion 302 (e.g., the user may select portion 302 by keeping a mouse button depressed while moving the cursor controlled by the mouse over portion 302). In other embodiments, portion 302 may be selected for OCR in response to a user interface device being used to draw a shape around portion 302. A drawn shape may be any polygon (e.g., a rectangle, square, etc.) or freehand shape that defines the area of image 206 on which OCR is to be performed. For example, a rectangle may be drawn around portion 302 via a touch-sensitive display screen or a pointing device (e.g., the user may depress a button of a pointing device while drawing a rectangle around portion 302). In further embodiments, portion 302 may be selected by a user interface device in response to a pointing action (e.g., a mouse button being depressed while its corresponding cursor is positioned over portion 302, a touch screen being touched in the area of portion 302, etc.). The system may, in some cases, assign a predefined boundary to a clicked portion of image 206. For example, the system may define portion 302 for OCR having a perimeter within a certain number of pixels from where image 206 was clicked or a perimeter having a predefined area (e.g., the system may use a rectangle having a predefined area and shape for portion 302). In yet another embodiment, OCR may be performed by the system to identify text that may be of interest to a user when completing expense form 204. For example, the system may highlight or otherwise signify that the text “158.00” in portion 302 of image 206 may be relevant to expense form 204. In return, the user may operate a pointing device, touch screen display, or other user interface device to select portion 302 based on its highlighting.

In cases in which portion 302 is selected before one of the input fields of expense form 204, the corresponding input field may also be selected in any number of different ways. In some embodiments, input field 210 may be selected by pointing a cursor over input field 210 and depressing a button of a pointing device. In another embodiment, input field 210 may be selected via a touch in the area of input field 210 detected by a touch screen display. According to further embodiments, the selection of portion 302 and its corresponding input field 210 may be received as a single motion from a user interface device. For example, the two may be selected via a swipe-and-drop motion (e.g., portion 302 is selected by swiping over portion 302 and “dropped” into input field 210 by depressing a button of a pointing device or placing a finger over input field 210 on a touch-screen display). In another example, a point-and-drop motion may be received as the selections of portion 302 and input field 210 (e.g., portion 302 and input field 210 may be “pointed” to by a user pointing to the two points on display 202 via a touch screen display or by positioning a cursor over the respective points and depressing a button.). In a further example, a draw-and-drop motion may be received as the selections of portions 302 and input field 210 (e.g., a shape is first drawn around portion 302 of image 206 using an interface device and then input field 210 is selected by depressing a button of the interface device or touching a touch screen display in the area of input field 210).

OCR may be performed by the system on portion 302 of image 206 in response to the received selection of portion 302, in one embodiment. Thus, the selection of input field 210 by an interface device may be performed in parallel or after the OCR completes. In another embodiment, the system may wait until input field 210 is also selected via a user interface device before performing OCR on portion 302. In a further embodiment, the system may perform OCR on image 206 as a whole to identify portion 302 based on it containing text that may be of relevance to expense form 204. For example, the system may highlight portion 302 as potentially containing relevant text before receiving the selection of portion 302.

In one example of operation, assume that the user of expense form 204 wishes to input data into expense form 204 using corresponding data from image 206. In such a case, the user may select portion 302 by operating a user interface device to point to portion 302, perform a swiping motion across portion 302, draw a shape around portion 302, or perform another such selection action. In response to the selection of portion 302, either the local system or a remote system performs OCR on portion 302 to identify the text “158.00” from image 206. The text may then be copied into a local memory location, such as a clipboard utility or other memory location associated with the application providing expense form 204 to display 202. Following the selection of portion 302, the user may then operate a user interface device to select input field 210 (e.g., by pointing to input field 210 via the interface device, by operating the interface device to drag portion 302 to input field 210, etc.). In response to the selection of input field 210, the system populates input field 210 with the identified text “158.00” from portion 302. Thus, the user is able to quickly complete expense form 204 and individually review the data inputted into expense form 204 using OCR on image 206.

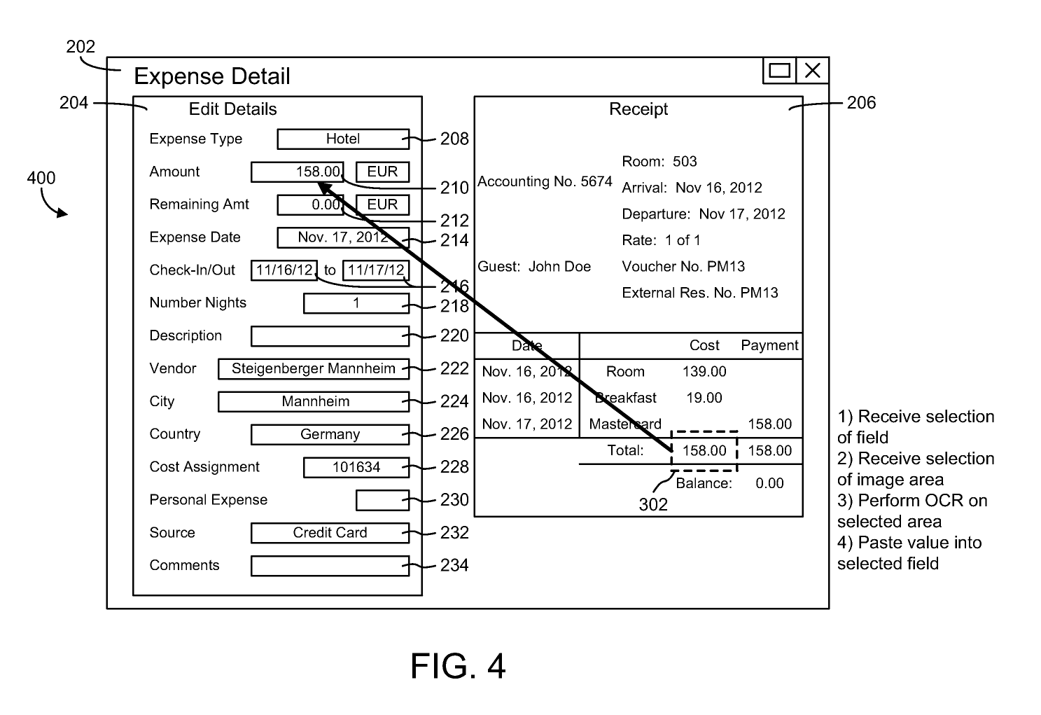

Referring now to FIG. 4, an illustration 400 is shown of character recognition being used on a portion of an image of an expense document to input data into an electronic expense form, according to an exemplary embodiment. In the example shown, assume that the same expense form 204 and image 206 are provided to display 202 as in FIGS. 3-4. In the embodiment shown, however, the ordering of selections is reversed from that of FIG. 3. In other words, one of the input fields of expense form 204 may be populated with text identified using OCR on image 206 by first receiving a selection of an input field.

In one example, assume that a user wishes to input text from image 206 into expense form 204. In such a case, he or she may first select input field 210 and then select portion 302 to initiate the OCR of portion 302 by the system. The system may then copy the recognized text from portion 302 into input field 210. According to one embodiment, the ordering of steps to copy text from image 206 into an input field of expense form 204 may be controlled by one or more parameters. In some embodiments, the copying process may be initiated via a user interface device before selection of an input field or image 206 (e.g., the OCR-based copying process may be initiated in response to the selection of a button).

According to various embodiments, the system may be configured to allow recognized text in image 206 to be selected first and/or an input field to be selected first. In one embodiment, if recognized text is selected before a corresponding input field, the system may place recognized text into a clipboard utility on the local device or within a memory area of the application providing expense form 204 to display 202 until a corresponding input field is selected. If an input field is selected first, the system may first check whether a value is present in the clipboard utility or memory location. If so, the system may paste the value into the input field. If not, selection of a portion of image 206 may cause the system to automatically populate the selected input field.

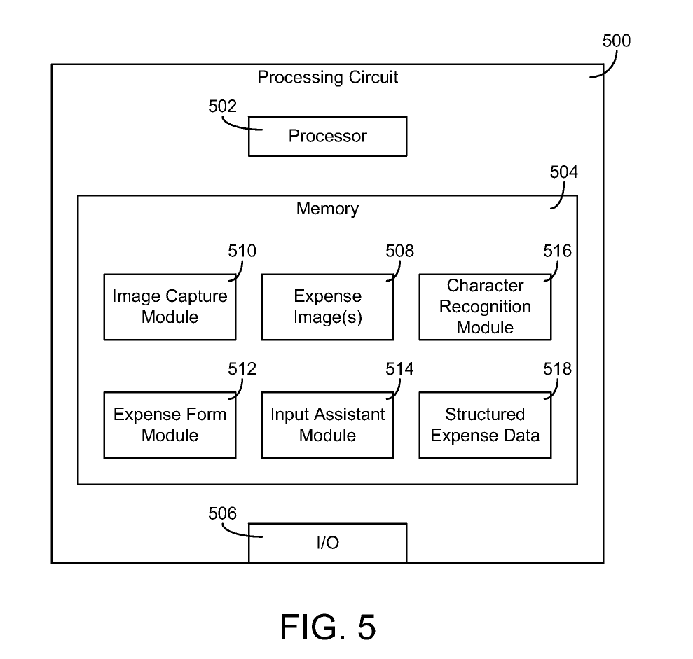

Referring now to FIG. 5, a schematic block diagram of a processing circuit 500 configured to facilitate the entry of expense data into an electronic expense form is shown, according to an exemplary embodiment. Processing circuit 500 may be part of a client device, expense management server, or a combination of computing devices part of an expense management system. Processing circuit 500 includes a memory 504 and processor 502. Processor 502 may be, or may include, one or more microprocessors, application specific integrated circuits (ASICs), circuits containing one or more processing components, a group of distributed processing components, circuitry for supporting a microprocessor, or other hardware configured for processing. According to an exemplary embodiment, processor 502 is configured to execute computer code stored in memory 504 to complete and facilitate the activities described herein. Memory 504 can be any volatile or non-volatile computer-readable storage medium capable of storing data or computer code relating to the activities described herein. For example, memory 504 is shown to include modules 510-516 which are computer code modules (e.g., executable code, object code, source code, script code, machine code, etc.) configured for execution by processor 502. According to some embodiments, processing circuit 500 may represent a collection of processing devices (e.g., servers, data centers, etc.). In such cases, processor 502 represents the collective processors of the devices and memory 504 represents the collective storage devices of the devices. When executed by processor 502, processing circuit 500 is configured to complete the activities described herein.

Processing circuit 500 includes hardware circuitry for supporting the execution of the computer code of modules 510-516. For example, processing circuit 500 is shown to include one or more hardware interfaces 506. Hardware interface 506 may include hardware to receive data from a network or serial BUS and to communicate data to another processing circuit via a network or serial BUS. Hardware interface 506 may be configured to receive or transmit data wirelessly (e.g., via radio signals, via infrared signals, etc.) or over a hardwired connection (e.g., a CAT5 cable, a fiber optic cable, etc.). For example, hardware interface 506 may receive one or more images 508 of expense documents from a peripheral camera or scanner, or from another computing device via a network connection. Hardware interface 506 may also communicate data to other devices, such as structured expense data 518. In some embodiments, hardware interface 506 may be configured to receive data from, or transmit data to, a user interaction device (e.g., a display, a mouse or other pointing device, etc.).

Memory 504 includes one or more images 508 of expense-related documents. Images 508 may include, but are not limited to, images of receipts, reservation confirmations, or invoices regarding expense items. For example, images 508 may include an image of a receipt from a hotel or a restaurant. In another example, images 508 may include an image of a traveler's airline ticket. Images 508 may include text in any human language and other aspects of internationalization. For example, a receipt from Germany may include text in German while a receipt from Australia may include text in English. Images 508 may be in any image format, such as JPEG, TIFF, GIF, or the like. The expense related documents of images 508 may be physical documents or electronic, in various embodiments. For example, one of images 508 may be an image of a paper receipt captured using a camera or scanner. In another example, one of images 508 may be a screen capture image of a payment confirmation webpage.

Memory 504 may include an image capture module 510, in some embodiments. Image capture module 510 is configured to generate or otherwise retrieve images 508. In some cases, image capture module 510 may receive images 508 from a digital camera or scanner via hardware interface 506. For example, processing circuit 500 may be part of a mobile device having an integrated camera and a user of the device may take a picture of a hotel receipt using the camera. In other cases, image capture module 510 may capture images 508 from a local display. For example, assume that a user has completed an online payment and is presented with a payment receipt webpage. In such a case, image capture module 510 may be configured to capture the displayed webpage as one of images 508. In a further embodiment, image capture module 510 may be configured to retrieve images 508 from a remote computing device via a network connection. For example, assume that a user has already uploaded one of images 508 to a remote expense management server, but has not yet completed an expense item form. In such a case, image capture module 510 may retrieve the corresponding image for presentation by the local device.

Memory 504 may include an expense form module 512 configured to present an electronic expense form to a display via hardware interface 506. In one embodiment, expense form module 512 may be part of a stand-alone application configured to provide the expense form to a local display. For example, expense form module 512 may be part of an application specifically configured to access an expense management server. In another embodiment, expense form module 512 may be part of a server-side application configured to cause an expense form to be displayed by a remote client device. For example, expense form module 512 may provide a webpage-based expense form to a remote client device.

An expense form provided by expense form module 512 may include any number of different input fields. The expense form may also be interactive, in some cases. For example, the types of input fields presented on the form may vary based on input from an interface device (e.g., a lodging-related expense form may differ from a meal-related expense form). In one embodiment, the expense form may be of a wizard-like configuration, allowing a user to enter expense data in a question and answer fashion. Input fields may be text fields configured to receive an input of one or more characters, checkboxes, radio buttons, drop down lists, or the like.

According to various embodiments, expense form module 512 is configured to provide one or more of images 508 to a display in conjunction with an expense form. An image may be displayed concurrently with the expense form or may be available for display in response to input from a user interface device. For example, a user may operate an interface device to select a menu or button to display one of images 508. In another example, a screen generated by expense form module 512 may display one or more of images 508 in a side-by-side manner with an expense form.

Memory 504 may also include an input assistant module 514 configured to facilitate the entry of data into an expense form generated by expense form module 512. Input assistant module 514 is configured to receive selections of an input field from an expense report and a portion of an expense image from a user interface device. A selection of a portion of an image may correspond to, but is not limited to, a pointing action performed using the interface device (e.g., a point and click action using a mouse, a tapping action using a touch screen, etc.), a swiping action performed using the interface device (e.g., a swipe of a finger over the portion detected by a touch screen display, a movement of a cursor across the portion via a pointing device, etc.), or a shape drawn around the portion of the image. Similarly, a selection of an input field of an expense form may correspond to an interface device detecting a user action regarding the input field (e.g., in response to a button of a pointing device being depressed while a cursor is positioned over the input field, in response a touch screen display detecting a touch in the area of the input field, etc.). In some embodiments, the selections of the input field and the portion of the image may correspond to a continuous action detected by a user interface device. For example, a user interface device may be used to perform a wipe-and-drop, point-and-drop, or draw-and-drop action to select both the portion of the image and the corresponding input field of the expense form. Input assistance module 514 may be configured to receive either the selection of the input field or the selection of the portion of the image first, in various embodiments.

Memory 504 may include a character recognition module 516 configured to perform optical character recognition on images 508 of expense-related documents. In various embodiments, character recognition module 516 receives an indication of a selected portion of a displayed image 508 and performs OCR on it. Character recognition module 516 may perform character recognition on the selected portion in response to the portion being selected or at a later time (e.g., after both an input field and portion of the image are selected). For example, if input assistant module 514 is configured to receive a selection of a portion of an expense image before a selection of an input screen, character recognition module 516 may simultaneously perform OCR on the portion of the image while the system is waiting for a user to select the corresponding input field of the expense form. In further embodiments, character recognition module 516 may perform character recognition on the entirety of images 508 and input assistant module 514 may provide an indication to a display regarding any recognized text that may be of relevance to the expense form. For example, character recognition module 516 may identify text in an expense image that may be relevant to an expense form and input assistant module 514 may highlight the text on the image. Such text may then be selected via a swiping motion, a pointing action, a drawn box, or the like, to transfer the text into a selected input field of the expense form. In yet another embodiment, a popup menu may be displayed to a user listing some or all of the OCR enabled input fields, thereby allowing a user to select the input field to which the recognized text is to be copied.

In response to receiving a selected portion of an expense image and a selection of an input field for an expense report, input assistant module 514 may populate the selected input field with text recognized in the selected portion of the image by character recognition module 516. For example, input assistant module 514 may temporarily store the text recognized by character recognition module 516 and paste the text into the selected input field of the expense report for display. As a result, the input field may be automatically populated by input assistant module 514 without further input from a user interface device (e.g., without receiving the text from a keypad). The populated field may be presented for review by a user and changed via input from a user interface device, in some embodiments, to ensure that the text recognized by character recognition module 516 is correct.

Expense form module 512 may also be configured to generate structured expense data 518 based on data entered into its input fields by input assistant module 514. In some embodiments, an input field of an expense report may be associated with metadata that describes data entered into the field and/or defines a data structure for the entered data. For example, a particular input field may have the metadata label “Expense Total” or “Check-In Date” for data entered into the field. In another example, the metadata may be used to structure an expense item according to a hierarchy of attributes. For example, one branch of a potential hierarchy may be Expense Item ID>Expense Type>Lodging>Check-In Date. In some cases, each of the metadata items may have a corresponding data value entered via an input field of the expense report (e.g., the “Check-In Date” metadata label may have a corresponding entered value of “Nov. 16, 2012”). In other cases, only some of the metadata may have corresponding entered values (e.g., some of the metadata is used solely to provide a structure for other metadata labels).

Structured expense data 518 may be provided by processing circuit 500 to another computing device, such as an expense management server. For example, structured expense data 518 may be provided in XML format or another structured data format to a web server of an expense management system for storage in the system. In some embodiments, structured expense data 518 may be stored in memory 504 or in another computing device in a relational database. In such a case, the metadata in structured expense data 518 may be used for purposes of data retrieval and reporting. For example, a database query may be executed to retrieve expense item data having one or more specified attributes (e.g., expense item data for a particular timeframe, geographic region, cost center, etc.).

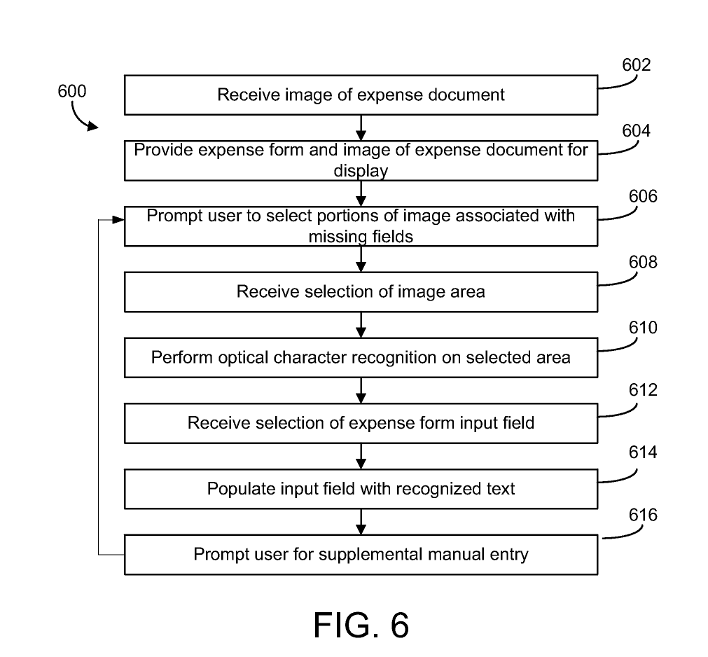

Referring now to FIG. 6, a flow diagram of a process 600 for inputting expense data into an expense management system is shown, according to an exemplary embodiment. Process 600 generally facilitates the entry of expense-related data into an electronic expense form based on an image of an expense-related document. Process 600 may be implemented by one or more processing circuits, such as processing circuit 500 shown in FIG. 5. For example, process 600 may be implemented by an expense management server, a client device of such a server, or a combination thereof within an expense management system.

Process 600 includes receiving an image of an expense document (step 602). An expense document may be, but is not limited to, a receipt, an order confirmation, a reservation confirmation, an invoice, or another form of expense-related document. The expense document may be in physical form (e.g., a paper receipt, etc.) or may be in electronic form (e.g., a screen of an application, a webpage, etc.). Any number of different imaging formats may be used for the image. For example, the image may be in JPG, GIF, TIFF, PNG, bitmap, or another such image format. In some embodiments, the image may be received from a peripheral device configured to capture a digital image of a physical document. For example, the image may be received from a peripheral camera, scanner, or other device configured to capture a digital representation of a document in an image format. In other embodiments, the image may be a screen capture. For example, the image may be a screen capture of an email, application screen, or webpage containing expense-related information. The image may also be received from a local device or from another computing device via a network, in various embodiments. For example, the image may first be uploaded to a server and retrieved for purposes of review at a client device.

Process 600 includes providing an expense form and the image for display (step 604). In general, an expense form may be any type of application screen, webpage, collection of webpages, or other graphical user interface configured to receive expense-related data as input from a user interface device. For example, an expense form may include any number of input fields configured to receive input data from a pointing device, touch screen display, keypad or other user interface device. In some embodiments, the image may be provided for display concurrently with the expense form. For example, an image of a receipt for a hotel stay may be presented concurrently with an expense form. The image may be presented in response to a request from a user interface device for the image, in response to the image being created or uploaded to the device, or automatically (e.g., without further input from the user interface device).

Process 600 includes prompting a user to select one or more portions of the expense image associated with missing fields (step 606). In some embodiments, the user may be prompted to select one or more portions of the expense image that corresponds to an input field of the expense form, or vice-versa. For example, an input wizard may be provided to the display that asks for the selection of an input field of the expense form or for the selection of a portion of the expense image that corresponds to an input field of the expense form. In another example, a highlighting or other graphical effect may be provided to the display to signify which input field of the expense form is to be populated using data from the expense image.

Process 600 includes receiving a selection of an area of the image from a user interface device (step 608). The selection may correspond to a click action (e.g., the depression of a button on a pointing device, a tapping of a finger on a touch screen display, etc.), a swiping action (e.g., the swiping of a finger along a touch screen display over the area, the depression of a button on a pointing device while dragging a cursor across the area, etc.), or a drawing of a shape around the area (e.g., the drawing of a box or other shape around the area via the user interface device). The selected area may correspond to the entirety of the image or a sub-portion of the image.

Process 600 includes performing character recognition on the selected area of the image (step 610). In various embodiments, OCR may be performed by the device receiving the selection of the image area or by another computing device (e.g., OCR may be performed locally by a client device or by an expense management server). The character recognition may identify characters on a character-by-character basis, word-by-word basis, or the like. In some implementations, the character recognition may recognize the language of any text in the selected area of the image and match an identified set of characters to a term in a dictionary, to identify a word or set of words in the image. Recognized text may be, but is not limited to, symbols, numbers, letters, words, or phrases. According to some embodiments, OCR may be performed on the image as a whole and identified text that may be of relevance to the expense form emphasized by the system. For example, the system may provide a highlighting of an identified word or value on the image, to alert a user to the presence of the text. In such a case, the text may still be selected in accordance with step 606 (e.g., via a clicking action, a swiping action, etc.).

Process 600 includes receiving a selection of an input field of the expense form from a user interface device (step 612). In some embodiments, the selection of an input field may correspond to a clicking action (e.g., the depression of a button of a user interface device, a tapping of a finger on a touch screen display over the field, etc.). In further embodiments, the selection of the image area in step 606 and the selection of the input field of the expense form in step 610 may be received as a single action from a user interface device. For example, an input field may be selected via a “dropping” action after the image area is selected (e.g., by dragging and dropping the selected area of the image into the input field via continuous touch of a touch screen display, via holding down a button of a pointing device, etc.). In yet another example, a popup menu or window may be presented to a display having a listing of some or all of the OCR enabled input fields, thereby allowing the user to select one of the input fields.

According to various embodiments, steps 604-608 may be performed concurrently or in a different order than that shown in FIG. 6. In some embodiments, step 608 may be performed before step 606 such that the input field of the expense form is selected prior to the selection of the image area. For example, the system may be configured to initiate the transfer of text from an image of an expense document to an expense form in response to a selection of an input field of the form. In further embodiments, step 608 may be performed before, during, or after either of steps 606, 610. For example, OCR may be performed on the image in response to the image being created or received. In one embodiment, step 606 may be performed in response to receiving a selection of a area of the image. Thus, steps 608 and 610 may be performed concurrently, in some implementations.

Process 600 includes populating the selected input field of the expense form with the recognized text from the image area (step 614). In response to receiving the selection of the input field and identifying text in the image area, the system may automatically populate the input field with the identified text (e.g., without further input from a user interface device). The text may be stored, in some cases, in a memory location of an application (e.g., the application providing the expense form to the display), a clipboard application, or the like. After the input field is selected, the system may then populate the input field with the recognized text for display.

According to various embodiments, the text used to populate the input field may be associated with the system with one or more metadata labels. For example, the text “105.55” may be associated with the metadata label “Total Owed” based on the type of input field. In some embodiments, any metadata labels associated with the text may also be associated with other metadata labels, thereby forming a structure for the data received via the expense form. For example, metadata labels for the input fields may be related to one another according to a hierarchy or other data structure, thereby categorizing and providing context for the entered expense data. In some embodiments, the resulting structured data generated via the expense form may be stored in a database for purposes of reporting and analysis. In such cases, any metadata associated with the values entered via the expense form may be used to retrieve, analyze, or report on different expense attributes (e.g., expense data broken down by expense type, time frame, location, etc.).

Process 600 includes prompting the user for supplemental manual entry of an input field of the expense form (step 616). In some implementations, the system may prompt the user to add additional information to the input field populated with the recognized text. For example, the user may be prompted to add any additional comments to a comment field populated with recognized text from the expense image. In further implementations, the user may be prompted for supplemental manual entry of any remaining input fields of the expense form. For example, the user may be prompted to manually enter text into any input fields of the expense form that do not have corresponding information contained in the image of the expense document.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, cloud computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A computerized method for inputting expense data comprising:
receiving, at a processing circuit, an image of an expense document;
providing the image for display with an expense form, the expense form having an input field with associated metadata;
receiving a selection of a portion of the image from an interface device;
performing, by the processing circuit, character recognition on the selected portion of the image to identify text in the selected portion of the image;
prompting the selection of an input field of the expense form;
populating, by the processing circuit, the input field of the expense form with the identified text from the image of the expense document; and
converting the expense form into structured data comprising the metadata associated with the input field and the identified text.

2. The method of claim 1, wherein the portion of the image is selected via a swiping motion across the portion of the image detected by the interface device.

3. The method of claim 1, further comprising:
receiving, from the interface device, a point and drop action to select the portion of the image and select the input field.

4. The method of claim 1, wherein the portion of the image is selected by detecting a shape drawn around the portion of the image using the interface device.

5. The method of claim 1, wherein the interface device comprises a touch screen display.

6. The method of claim 1, wherein the portion of the image is selected from a predetermined, highlighted portion of the image.

7. The method of claim 1, further comprising:
receiving the image of the expense document from a camera.

8. The method of claim 1, further comprising:
copying, by the processing circuit, the identified text to a clipboard utility in response to the text being identified by performing character recognition on the selected portion of the image; and
pasting, by the processing circuit, the identified text from the clipboard utility to the input field in response to receiving the selection of the input field.

9. The method of claim 1, wherein the expense form is a travel expense form.

10. A system for inputting expense data comprising a processing circuit configured to:
receive an image of an expense document;
provide the image for display with an expense form, the expense form having an input field with associated metadata;
receive a selection of a portion of the image from an interface device;
perform character recognition on the selected portion of the image to identify text in the selected portion of the image;
prompt the selection of an input field of the expense form;
populate the input field of the expense form with the identified text from the image of the expense document; and
convert the expense form into structured data comprising the metadata associated with the input field and the identified text.

11. The system of claim 10, wherein the portion of the image is selected via a swiping motion across the portion of the image detected by the interface device.

12. The system of claim 10, wherein the processing circuit is configured to receive, from the interface device, a point and drop action to select the portion of the image and select the input field.

13. The system of claim 10, wherein the portion of the image is selected by detecting a shape drawn around the portion of the image using the interface device.

14. The system of claim 10, wherein the interface device comprises a touch screen display.

15. The system of claim 10, wherein the portion of the image is selected from a predetermined, highlighted portion of the image.

16. The system of claim 10, wherein the processing circuit is configured to receive the image of the expense document from a camera.

17. The system of claim 10, wherein the processing circuit is configured to copy the identified text to a clipboard utility in response to the text being identified by performing character recognition on the selected portion of the image, and wherein the processing circuit is configured to paste the identified text from the clipboard utility to the input field in response to receiving the selection of the input field.

18. The system of claim 10, wherein the expense form is a travel expense form.

19. A computer-readable storage medium having machine instructions stored therein, the instructions being executable by a processor to cause the processor to perform operations comprising:
receiving an image of an expense document;
providing the image for display with an expense form, the expense form having an input field with associated metadata;
receiving a selection of a portion of the image from an interface device;
performing character recognition on the selected portion of the image to identify text in the selected portion of the image;
prompting the selection of an input field of the expense form;
populating the input field of the expense form with the identified text from the image of the expense document; and
converting the expense form into structured data comprising the metadata associated with the input field and the identified text.

20. The computer-readable storage medium of claim 19, wherein the operations further comprise:
storing the structured data in a relational database.

21. The method of claim 1, wherein the interface device comprises a pointing device.

22. The system of claim 10, wherein the interface device comprises a pointing device.
